(19) United States
(12) Patent Application Publication
(10) Pub. No.: US 2024/0339776 A1
(43) Pub. Date: Oct. 10, 2024

(54) High Current Pogo-pin Connector

(71) Applicant: Balint Altdorfer, BELPRE, OH (US)

(72) Inventor: Balint Altdorfer, BELPRE, OH (US)

(21) Appl. No.: 18/131,825

(22) Filed: Apr. 6, 2023

(51) Int. Cl. H01R 13/24; H01R 13/04

(52) U.S. Cl. CPC H01R 13/2421; H01R 13/04

(57) ABSTRACT

Disclosed is a Pogo-pin connector for high electrical current conduction which includes at least one conductive Pogo-pin terminal, at least one spring part, and at least one insulating disk assembled in an insulating body respectively. The insulating disk is firmly fastened into the bottom end of the insulating body. The spring-bias conductive Pogo-pin terminal is movably protruding through the top opening of the insulating body and the opening of the insulating disk providing a direct path for the electrical current between the top of the conductive Pogo-pin terminal to the bottom of the same terminal. In accordance with the configuration, the primary component of the invention, the spring-bias conductive Pogo-pin terminal eliminates any transient current interruption problem and any electrical arcing effect even in a vibrating environment, since the electric current is going through only one single conducting component.

### BACKGROUND OF THE INVENTION

### Field of the Invention

The present invention relates to the technical field of electric connectors, in particular to a Pogo-pin connector for high electric current conduction.

### Description of the Related Art

Conventionally, a Pogo-pin connector 200 (FIG. 5) includes three basic conducting components, namely a conducting housing 21, a conducting pin-terminal 22 and a conducting spring 23. The pin-terminal and the spring are compressed in the housing, while the tip 25 of the spring-bias pin-terminal 22 is appearing through the top opening of the housing 24. In use, the pin-terminal 22 is forced toward the inside of the housing 21 to compress the spring 23, the spring forces the pin-terminal against the inside wall of the housing, thus achieving electric connection to conduct the electricity from the tip 25 of the pin-terminal to the bottom 26 of the housing.

Since all three basic components of the conventional Pogo-pin connector assembly are partaking in conducting the electricity, that may cause transient current interruption problems, especially in a vibrating environment. A spark may occur between the three basic conductive components due to an electrical arcing effect therebetween. This might invoke the connecting components to get charred and burnt.

Thus conventional Pogo-pin connectors are rarely used for high current applications.

### SUMMARY OF THE INVENTION

An object of the current invention is to eliminate the transient current interruption problem and electrical arcing caused by the multiple conducting components used in conventional Pogo-pin connectors.

Another object of the invention is to provide a pogo-pin connector that is not subject to the transient current interruption problem.

Further object of the invention provides a pogo-pin which includes at least one conductive pogo-pin terminal, at least one spring part, and at least one insulating disk assembled in an insulating body respectively.

A still further object of the invention is to provide a pogo-pin connector which reduces the number of the conducting components to one single conducting component for electric conduction between one end of the connector assembly to the other end of the connector assembly.

Further object of the invention is to provide a pogo-pin which has an improved effectiveness and safety of the electric conduction making the same suitable for high electric current conduction even in vibrating environments.

### BRIEF DESCRIPTION OF THE DRAWING

Having thus described the disclosure in the foregoing general terms, reference will now be made to the accompanying drawings, which are not necessarily drawn to scale, and wherein:

FIG. 1 illustrates a perspective view of the pogo-pin connector according to the present invention;

FIG. 2 illustrates a perspective view of the pogo-pin connector in use according to the present invention;

FIG. 3A illustrates a front view of the pogo-pin connector according to the present invention;

FIG. 3B illustrates a corresponding section view of the pogo-pin connector of FIG. 3A, according to the present invention;

FIG. 4 is an exploded perspective view illustrating the pogo-pin connector of FIG. 1;

FIG. 5 is a cross-sectional view illustrating a conventional pogo-pin connector;

### DETAILED DESCRIPTION OF THE PREFERRED EMBODIMENTS

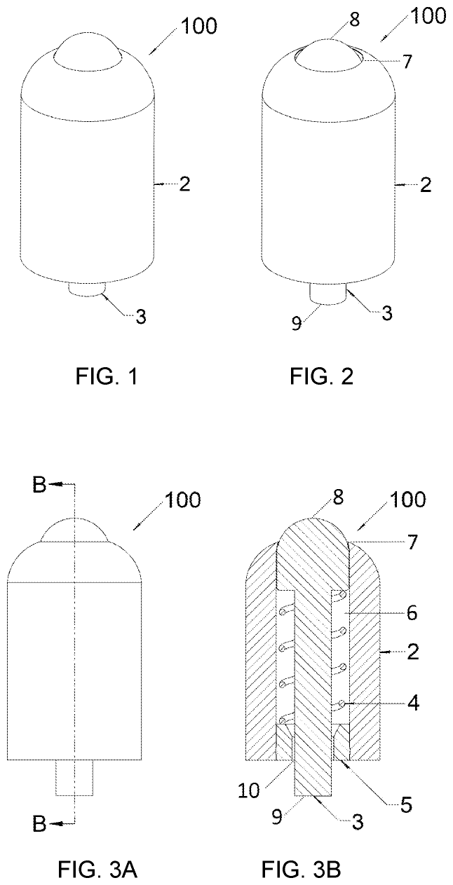

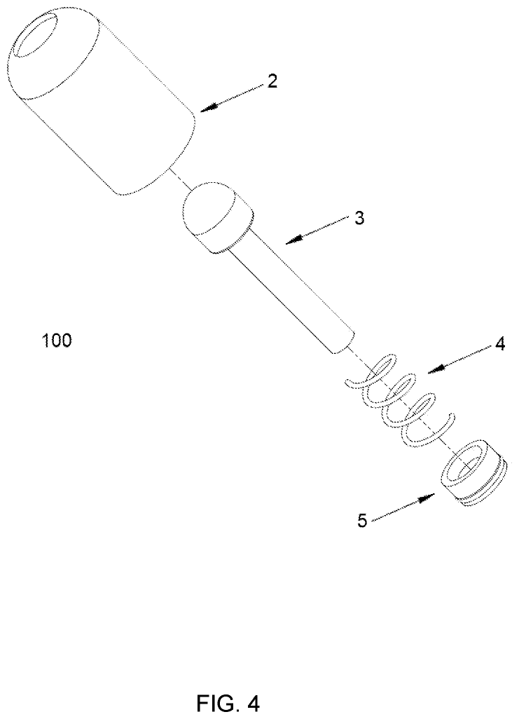

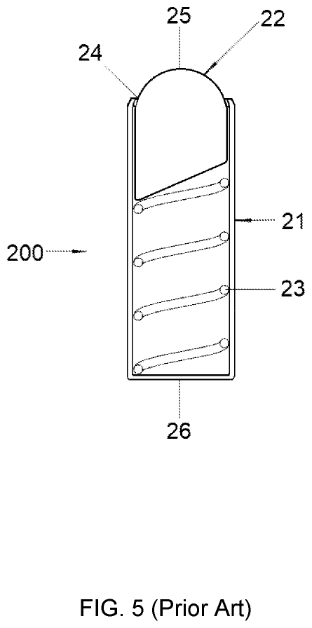

Referring now to FIGS. 1-4, a Pogo-pin connector 100 in accordance with the present invention shown comprises at least one conductive pogo-pin terminal 3 and at least one spring part 4, assembled respectively inside an insulating body 2 with at least one insulating disk 5 firmly fastened into the bottom end of the insulating body to enclose it thereby.

Referring further to FIGS. 1-4, in accordance with the present invention, a conductive pogo-pin terminal 3 considered to be the primary component of the invention is specifically designed to handle high electric current is disclosed.

The insulating body 2 is provided with a receiving cavity 6, which receives the pogo-pin terminal 3 and spring 4 which are inserted forward in the receiving cavity 6 of the insulating body 2. The top 8 of the spring-bias pogo-pin terminal is movably protruding through the top opening 7 of the insulating body 2.

The insulating disk 5 is assembled forward in the receiving cavity 6 of the insulating body 2 and firmly encloses the spring-bias pogo-pin terminal 3 in the insulating body in a movable fashion.

The bottom 9 of the conductive pogo-pin terminal is movably protruding through the opening 10 of the insulating disk 5.

Referring to FIG. 2 again, in use, the top 8 of the pogo-pin terminal 3 slides toward the inside of the insulating body 2 through its top opening 7, and thus the bottom 9 of the pogo-pin terminal protrudes out further through the opening 10 of the insulating disk 5.

Referring to FIG. 2 again, the sole element that conducts electricity in the Pogo-pin connector 100 is the pogo-pin terminal 3 itself, providing a direct path for the electrical current from the top 8 of the conductive pogo-pin terminal to the bottom 9 of the same terminal, without any other electric connections required inside 6 the Pogo-pin connector assembly 100, since the spring part 4 is not partaking in the electric conduction.

What is claimed is:

1. A Pogo-pin connector, comprising:
at least one conductive Pogo-pin terminal; and
at least one spring part;
wherein,
the said conductive Pogo-pin terminal and the said spring part, are assembled in the receiving cavity of the insulating body with at least one insulating disk firmly fastened into the bottom opening of said insulating body to enclose it thereby.

2. The Pogo-pin connector as claimed in claim 1, wherein the said spring-bias conductive Pogo-pin terminal is movably protruding through the top opening of said insulating body and also through the bottom of the said insulating body through the opening of the said enclosing insulating disc.

3. The Pogo-pin connector as claimed in claim 2, wherein in use, the said top of the said spring-bias Pogo-pin terminal slides toward the inside of the said insulating body through its said top opening and thus the bottom of the said Pogo-pin terminal protrudes out further through the said opening of the insulating disk.

4. The Pogo-pin connector as claimed in claim 1, wherein the said Pogo-pin terminal in use is providing a direct path for the electrical current between the top of the conductive Pogo-pin terminal to the bottom of the same terminal.
